(19) United States
(12) Patent Application Publication
(10) Pub. No.: US 2025/0080671 A1
(43) Pub. Date: Mar. 6, 2025

(54) ELECTRONIC APPARATUS AND CONTROL METHOD FOR ELECTRONIC APPARATUS

(71) Applicant: CANON KABUSHIKI KAISHA, Tokyo (JP)

(72) Inventor: YO KOBAYASHI, Chiba (JP)

(21) Appl. No.: 18/818,347

(22) Filed: Aug. 28, 2024

(30) Foreign Application Priority Data
Sep. 4, 2023 (JP) 2023-142747

(51) Int. Cl. H04N 1/00

(52) U.S. Cl. CPC H04N 1/00896

(57) ABSTRACT

An electronic apparatus includes a first substrate on which a first central processing unit (CPU) is mounted, a second substrate on which a second CPU is mounted and a specific function is mountable, and a power supply control unit configured to control power supply from a power source, wherein the power supply control unit controls the power supply to the second CPU when the electronic apparatus shifts to a power saving state depending on a determination result of whether the power supply to the second CPU is required in a case where the electronic apparatus is in the power saving state based on whether the specific function is mounted on the second substrate.

### BACKGROUND

### Field of the Disclosure

The present disclosure relates to an electronic apparatus, and a control method for the electronic apparatus.

### Description of the Related Art

In recent years, with Green Transformation (GX) and reduction in running cost in an office as a backdrop, there has been a demand for power saving of an image forming apparatus, such as a multi-functional printer (MFP). For this reason, it is demanded to, for example, not only proactively shift the MFP to a power saving state, but also significantly reduce power consumption in the power saving state.

On the other hand, in general, when an image forming apparatus shifts to the power saving state, it takes time to return the image forming apparatus to a state where the power consumption is high and the image forming apparatus can perform printing and scanning, which reduces user's convenience. Thus, there is a trade-off relationship. For this reason, some users want an image forming apparatus capable of returning from the power saving state by a plurality of return factors, such as a human detection sensor.

For example, Japanese Patent Application Laid-Open No. 2022-113365 discusses a technique with which a user can input a plurality of instructions to an operation unit of an electronic device, and a control unit changes a power state of the electronic device based on the instructions. In this way, it is possible to achieve the electronic device that can shift to a state with a lower power consumption and a power saving state with a slightly higher power consumption but a shorter recovery time.

### SUMMARY

According to an aspect of the present disclosure, an electronic apparatus includes a first substrate on which a first central processing unit (CPU) is mounted, a second substrate on which a second CPU is mounted and a specific function is mountable, and a power supply control unit configured to control power supply from a power source, wherein the power supply control unit controls the power supply to the second CPU when the electronic apparatus shifts to a power saving state depending on a determination result of whether the power supply to the second CPU is required in a case where the electronic apparatus is in the power saving state based on whether the specific function is mounted on the second substrate.

Further features of various embodiments will become apparent from the following description of exemplary embodiments with reference to the attached drawings.

### BRIEF DESCRIPTION OF THE DRAWINGS

FIG. 1 is a block diagram illustrating a system configuration of an image forming apparatus according to a first exemplary embodiment of the present disclosure.

FIG. 2 is a block diagram illustrating a detailed configuration of an operation unit according to the first exemplary embodiment of the present disclosure.

FIG. 3 is a block diagram illustrating a power supply system of the operation unit according to the first exemplary embodiment of the present disclosure.

FIG. 4A is a connection diagram illustrating a control unit and an operation unit in a configuration that minimizes power consumption according to the first exemplary embodiment of the present disclosure, and FIG. 4B is a connection diagram illustrating the control unit and the operation unit in a configuration that prioritizes a recovery time to a normal operation state according to the first exemplary embodiment of the present disclosure.

FIG. 5A is a power supply reset sequence diagram in the configuration that minimizes the power consumption according to the first exemplary embodiment of the present disclosure, and FIG. 5B is a power supply reset sequence diagram in the configuration that prioritizes the recovery time to the normal operation state according to the first exemplary embodiment of the present disclosure.

FIG. 6 is a block diagram illustrating a system configuration of an image forming apparatus according to a second exemplary embodiment of the present disclosure.

FIG. 7 is a block diagram illustrating a detailed configuration of an operation unit according to the second exemplary embodiment of the present disclosure.

FIG. 8A is a connection diagram illustrating a control unit and an operation unit in a configuration that minimizes power consumption according to the second exemplary embodiment of the present disclosure, and FIG. 8B is a connection diagram illustrating the control unit and the operation unit in a configuration that prioritizes a recovery time to a normal operation state according to the second exemplary embodiment of the present disclosure.

FIG. 9A is a power supply reset sequence diagram in the configuration that minimizes the power consumption according to the second exemplary embodiment of the present disclosure, and FIG. 9B is a power supply reset sequence diagram in the configuration that prioritizes the recovery time to the normal operation state according to the second exemplary embodiment of the present disclosure.

FIG. 10 is a block diagram illustrating a system configuration of an image forming apparatus according to a third exemplary embodiment of the present disclosure.

FIG. 11 is a block diagram illustrating a detailed configuration of an operation unit according to the third exemplary embodiment of the present disclosure.

FIG. 12A is a connection diagram illustrating a control unit and an operation unit in a configuration that minimizes power consumption according to the third exemplary embodiment of the present disclosure, and FIG. 12B is a connection diagram illustrating the control unit and the operation unit in a configuration that prioritizes a recovery time to a normal operation state according to the third exemplary embodiment of the present disclosure.

FIG. 13A is a power supply reset sequence diagram in the configuration that minimizes the power consumption according to the third exemplary embodiment of the present disclosure, and FIG. 13B is a power supply reset sequence diagram in the configuration that prioritizes the recovery time to the normal operation state according to the third exemplary embodiment of the present disclosure.

### DESCRIPTION OF THE EMBODIMENTS

Hereinbelow, exemplary embodiments of the present disclosure will be described with reference to the attached drawings. Components described in the exemplary embodiments are merely examples, and not intended to limit the scope of every embodiment thereto.

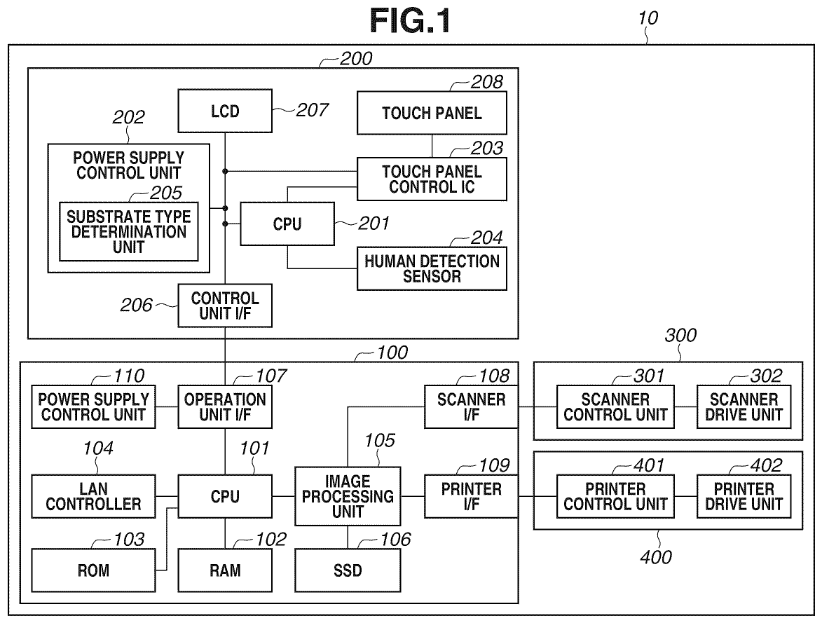

First, with reference to FIG. 1, a system configuration of an image forming apparatus 10 according to a first exemplary embodiment will be described.

As illustrated in FIG. 1, the image forming apparatus 10 includes a control unit 100 configured as a first substrate, an operation unit 200 configured as a second substrate, a scanner unit 300, and a printer unit 400. The substrates in the present exemplary embodiment are printed circuit boards.

The control unit 100 includes a central processing unit (CPU) 101 that performs control of a power state of the image forming apparatus 10 and handling of a print job transmitted from a peripheral device, such as a personal computer (PC). When the system of the image forming apparatus 10 starts up, first, the CPU 101 executes a boot program stored in a read only memory (ROM) 103 and loads data thereof into a random access memory (RAM) 102. In other words, the RAM 102 is used as a work memory for the CPU 101. The boot program is, for example, a Basic Input Output System (BIOS), a Boot Loader, or an Operating System (OS).

The CPU 101 is connected with a local area network (LAN) controller 104. The LAN controller 104 is connected with a peripheral device, such as a PC, based on an Ethernet standard and communicates with the peripheral device using a protocol of Transmission Control Protocol/Internet Protocol (TCP/IP). The CPU 101 and the LAN controller 104 are connected via, for example, a Peripheral Component Interconnect Express (PCIe) bus. In a case where a print job is transmitted from a PC via Ethernet, a packet received by the LAN controller 104 is transmitted to the CPU 101. In response to the transmitted print job, the CPU 101 transmits, to an image processing unit 105, an instruction to drive the scanner unit 300 or the printer unit 400.

In addition to the controls described above, the image processing unit 105 also has a function of performing image processing, such as noise reduction, on scan data of a document input from the scanner unit 300. Then, the image processing unit 105 stores the processed image data in a solid state drive (SSD) 106, converts the processed image data into image data in a format understandable by the printer unit 400, and transmits the converted image data to the printer unit 400, to achieve printing on a paper medium. For example, the image data obtained by the scanner unit 300 is expressed in red, green, and blue (RGB), but since the printer unit 400 processes the image data in yellow, magenta, cyan, and black (YMCK), conversion of the image data is required. In FIG. 1, the control unit 100 is connected with the operation unit 200 via an operation unit interface (I/F) 107, with the scanner unit 300 via a scanner I/F 108, and with the printer unit 400 via a printer I/F 109.

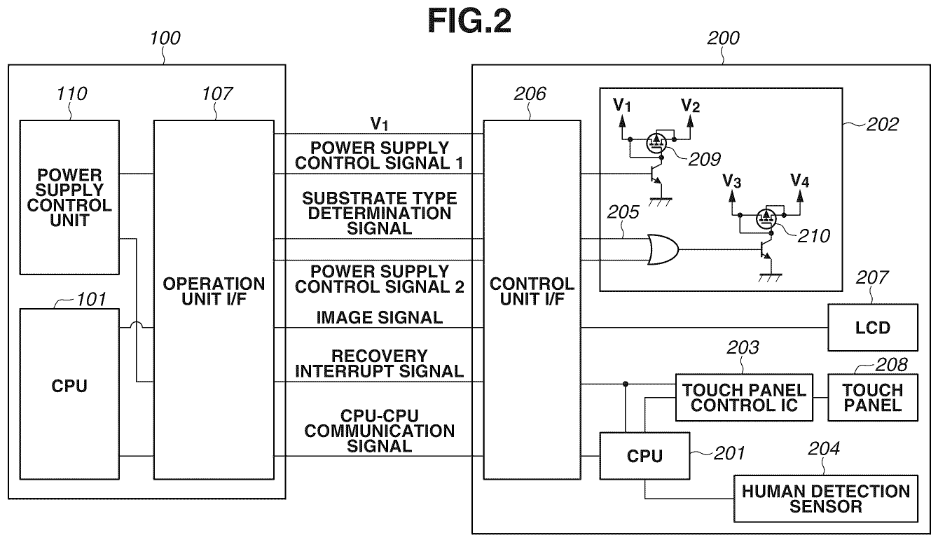

A power supply control unit 110 performs power supply control of functional modules, such as the CPU 101 and the RAM 102, included in the control unit 100. In addition, in the present exemplary embodiment, the power supply control unit 110 also transmits a power supply control signal to the operation unit 200. Details thereof will be described below with reference to FIG. 2.

The power supply control unit 110 controls the power supply to optimize the power consumption of the image forming apparatus 10. In the present exemplary embodiment, the image forming apparatus 10 has a first power state in which the scanner unit 300 and the printer unit 400 are energized and the image forming apparatus 10 is operable in response to a user's instruction or an input of a print job from a peripheral device. The image forming apparatus 10 also has a second power state with a power consumption less than that in the first power state. Further, the image forming apparatus 10 has a third power state where the image forming apparatus 10 is turned off. Assume that the image forming apparatus 10 has at least these three power states. In the present exemplary embodiment, the second power state refers to, for example, a sleep mode, and is a state where power to the CPU 101 of the control unit 100 is shut off and the program is held in the RAM 102. At this time, since the image forming apparatus 10 needs to respond to a print job from a peripheral device, the power supply control unit 110 performs the power supply control to supply power to the LAN controller 104. Since the power consumption needs to be reduced as much as possible in the sleep mode, the power supply control unit 110 performs the power supply control not to supply power to the scanner unit 300, the printer unit 400, and the functional modules in the control unit 100.

The scanner unit 300 includes a scanner control unit 301 and a scanner drive unit 302. The scanner control unit 301 controls the scanner drive unit 302 to scan a paper medium placed on a document platen (not illustrated) included in the image forming apparatus 10 to obtain image data thereof. For example, as the scanner drive unit 302, a mechanism called an auto document feeder (ADF) that automatically scans a paper medium is used. In addition, the scanner drive unit 302 performs scanning by driving a sensor module that converts reflected light obtained by irradiating a paper medium with light emitted from a light emitting diode (LED), into color information.

The printer unit 400 includes a printer control unit 401 and a printer drive unit 402. The printer control unit 401 controls the printer drive unit 402 to print an image or a character on a paper medium stored in the image forming apparatus 10. The printer control unit 401 drives, for example, a drum for charging a paper medium, and a laser unit irradiating the charged paper medium with laser light.

The operation unit 200 is connected with the control unit 100 via a control unit I/F 206, and mainly has a function of displaying a state of the image forming apparatus 10 to a user and a function of accepting various kinds of instructions from the user. A liquid crystal display (LCD) 207 is used for the function of displaying, and a touch panel 208 is used for the function of accepting the various kinds of instructions. More specifically, the touch panel 208 is attached onto the LCD 207 to be used, and a graphical user interface (GUI), such as various kinds of buttons, displayed on the LCD 207 is displayed to the user through the touch panel 208. A user can press the touch panel 208 with a finger or a pen to cause the image forming apparatus 10 to execute desired processing. Examples of the touch panel 208 include a resistive film type touch panel and a capacitance type touch panel.

A CPU 201 notifies the control unit 100 of the various kinds of instructions input by the user. As described above, the user presses a button displayed on the operation unit 200 via the touch panel 208. At this time, a touch panel control integrated circuit (IC) 203 acquires coordinate information indicating which position is pressed on the touch panel 208, and outputs an interrupt signal to the CPU 201. Upon receiving the interrupt signal, the CPU 201 acquires the coordinate information from the touch panel control IC 203. The CPU 201 transmits the acquired coordinate information to the CPU 101.

In addition, there is a case where the operation unit 200 includes a human detection sensor 204. Examples of the human detection sensor 204 include a pyroelectric sensor and an ultrasonic sensor, and the human detection sensor 204 is used to detect a user approaching the image forming apparatus 10. A signal for controlling an ultrasonic wave output from the human detection sensor 204 to the outside of the image forming apparatus 10 is controlled by the CPU 101. As a specific example of a use case of the human detection sensor 204, there is a use case where the image forming apparatus 10 starts returning from the second power state to the first power state when the human detection sensor 204 detects a user approaching the image forming apparatus 10. Further, before the user reaches the front of the image forming apparatus 10, an image is displayed on the LCD 207, and before the user starts operating the touch panel 208, the image forming apparatus 10 is caused to shift to the first power state. As described above, the CPU 101 is not energized in the second power state, but the CPU 201 notifies the power supply control unit 110 of the user's approach detected by the human detection sensor 204. Then, energization of the CPU 101 is started to return the image forming apparatus 10 to the first power state without any user's instruction being input.

On the other hand, the human detection sensor 204 may be configured to be mountable afterward as an option. There is a case where the human detection sensor 204 is not mounted on the operation unit 200, and in such a case, a user presses the touch panel 208 to return the image forming apparatus 10 from the second power state to the first power state. The interrupt signal indicating that the touch panel 208 is pressed is directly transmitted from the touch panel control IC 203 to the power supply control unit 110 of the control unit 100. Assume that the CPU 201 is not energized in this case.

More specifically, there are two power states further in the second power state depending on whether the human detection sensor 204 is mounted. In a case where the human detection sensor 204 is mounted, the CPU 201 and the human detection sensor 204 need to be energized in the second power state, and thus the power consumption becomes high. In a case where the human detection sensor 204 is not mounted, the CPU 201 is not energized in the second power state, and thus the power consumption becomes low. Naturally, the recovery time from the second power state to the first power state is short in the former case, and the recovery time is long in the latter case. Further, in the present exemplary embodiment, the description is given of the case where the human detection sensor 204 is mounted, but it is not limited thereto. For example, as the operation unit 200, any one of an operation unit with the human detection sensor 204 mounted thereon and an operation unit without the human detection sensor 204 mounted thereon can be attached to the image forming apparatus 10, and the control may be performed depending on which of the operation units is attached thereto.

Further, the operation unit 200 includes a power supply control unit 202 that performs power supply control of the CPU 201, and functional modules in the operation unit 200, such as the touch panel control IC 203. Further, the power supply control unit 202 includes a substrate type determination unit 205. The substrate type determination unit 205 determines a (substrate) type of the connected control unit 100 using a potential of a signal line connected between the operation unit I/F 107 and the control unit I/F 206. Also, the signal line in the present exemplary embodiment may be a transmission line. A determination result is fed back to the power supply control unit 202 to optimize the power supply control of the functional modules in the operation unit 200. Details thereof will be described with reference to FIG. 2 and subsequent diagrams.

FIG. 2 is a block diagram illustrating details of a connection state between the control unit 100 and the operation unit 200. As described above, the operation unit I/F 107 and the control unit I/F 206 are connected. The CPU 101 and the power supply control unit 110 are connected to the operation unit I/F 107. Further, the power supply control unit 202, the substrate type determination unit 205, the CPU 201, the touch panel control IC 203, and the LCD 207 are connected to the control unit I/F 206. In the present exemplary embodiment, the substrate type determination unit 205 is implemented by a single signal line. The operation unit I/F 107 and the control unit I/F 206 are connected based on a communication standard capable of transmitting an image signal, such as Display Port and High-Definition Multimedia Interface (HDMI®).

Now, power supplies and signals supplied and received between the operation unit I/F 107 and the control unit I/F 206 will be described. A power supply voltage V₁ is a power supply voltage for the operation unit 200 supplied from a power supply circuit (not illustrated) included in the control unit 100. Further, the power supply control unit 110 transmits a power supply control signal 1 to the power supply control unit 202. The power supply control signal 1 is used to control a power supply control circuit 209 included in the power supply control unit 202. Further, a substrate type determination signal and a power supply control signal 2 are transmitted from the operation unit I/F 107 to the power supply control unit 202, and used to control a power supply control circuit 210. As described above, in the present exemplary embodiment, since the substrate type determination signal corresponds to the substrate type determination unit 205 in FIG. 1 and is used in the power supply control unit 202, the substrate type determination unit 205 is included in the power supply control unit 202. Further, in FIG. 2, each of the substrate type determination signal and the power supply control signal 2 is a signal generated by a circuit (not illustrated), and a potential thereof becomes either of two values of high and low. More specifically, a potential higher than a threshold value is defined as high, and a potential lower than the threshold value is defined as low.

The image signal is transmitted from the CPU 101 to the LCD 207 via the operation unit I/F 107 and the control unit I/F 206. The CPU 101 transmits image information generated by a not-illustrated graphic processing unit (GPU), using the image signal. The touch panel control IC 203 transmits an interrupt signal to the power supply control unit 110 to notify the power supply control unit 110 that the touch panel 208 is pressed by a user, as a recovery interrupt signal. In a case where the human detection sensor 204 is mounted, and when the CPU 201 determines that the human detection sensor 204 has detected a user's approach, the human detection sensor 204 outputs a recovery interrupt signal. Finally, in a case where the CPU 101 and the CPU 201 communicate data with each other, a CPU-CPU communication signal (i.e., communication signal between CPUs) is used. For example, as described above, in the case where the CPU 101 acquires the coordinate information indicating the pressed position on the touch panel 208 acquired by the CPU 201, the CPU-CPU communication signal is used.

Now, the power supply control circuit 209 and the power supply control circuit 210 in the power supply control unit 202 will be described. When the power supply control signal 1 output from the power supply control unit 110 is asserted, the power supply control circuit 209 generates a power supply voltage V₂ from the power supply voltage V₁ supplied from the control unit 100. The power supply control circuit 210 is controlled by a logic IC that generates a logical sum of the substrate type determination signal (substrate type determination unit 205) and the power supply control signal 2. In a case where the logic IC asserts an output signal, a power supply voltage V₄ is generated from a power supply voltage V₃ described below.

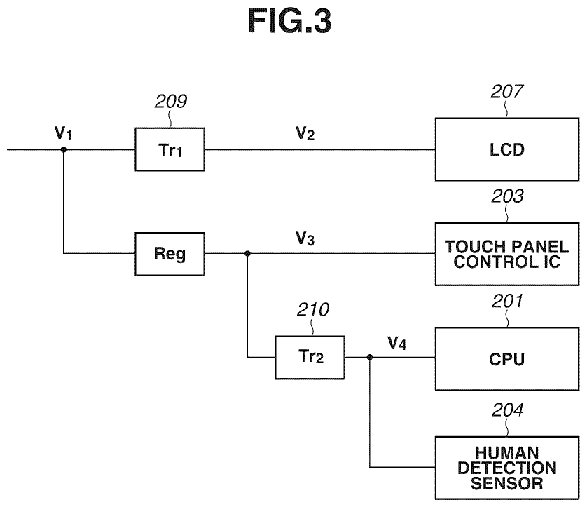

Now, with reference to FIG. 3, the power supply voltages V₁ to V₄ in FIG. 2 will be described in detail. As described above, the power supply voltage V₁ is a power supply voltage supplied from the control unit 100 to the operation unit 200. The power supply voltages V₂ to V₄ are power supply voltages generated by transistors (Trs) and/or a regulator (Reg) based on the power supply voltage V₁, and supplied to the functional modules in the operation unit 200.

The power supply voltage V₂ is a power supply voltage generated by a transistor Tr₁ based on the power supply voltage V₁ and supplied to the LCD 207. The transistor Tr₁ corresponds to the power supply control circuit 209 in FIG. 2. The power supply voltage V₃ is a power supply voltage generated by a regulator Reg based on the power supply voltage V₁ and supplied to the touch panel control IC 203. Further, the power supply voltage V₃ is also used to generate the power supply voltage V₄ as an input power supply to a transistor Tr₂. The power supply voltage V₄ is supplied to the CPU 201 and the human detection sensor 204. Naturally, the power supply voltage V₄ is not supplied in a case where the human detection sensor 204 is not mounted. The transistor Tr₂ corresponds to the power supply control circuit 210 in FIG. 2. Further, the power supply voltage V₃ is a power supply voltage turned on while the power supply voltage V₁ is supplied. For example, an enable terminal of the regulator Reg that generates the power supply voltage V₃ from the power supply voltage V₁ is pulled up to the power supply voltage V₁, which is an input to the regulator Reg.

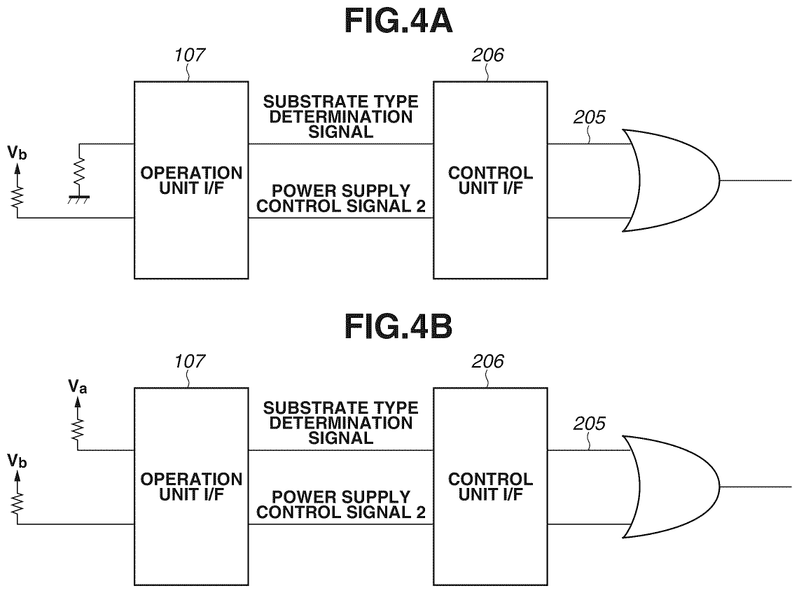

Next, with reference to FIG. 4A, states of potentials of the substrate type determination signal and the power supply control signal 2 will be described. FIG. 4A is a diagram illustrating a case where the operation unit 200 is connected to the control unit 100 in a configuration in which the human detection sensor 204 is not mounted, i.e., the power consumption is significantly reduced in the second power state. In FIG. 4A, since the substrate type determination signal is pulled down at a terminal of the operation unit I/F 107 of the control unit 100, the potential thereof is low. Thus, in the case where the substrate type determination signal is low, it is possible to determine that the human detection sensor 204 is not mounted. Further, since the power supply control signal 2 is pulled up to a power supply voltage V_{b} at a terminal of the operation unit I/F 107 of the control unit 100, it becomes high in a case where the power supply voltage V_{b} is turned on.

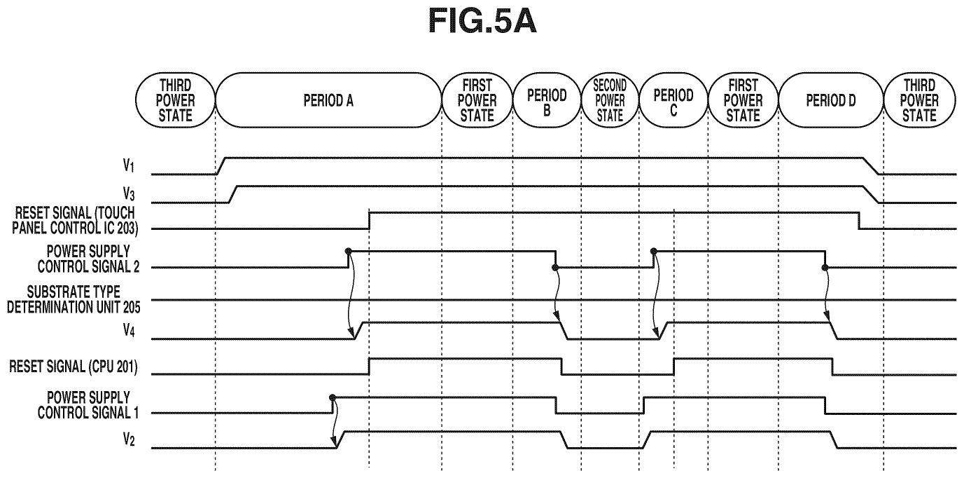

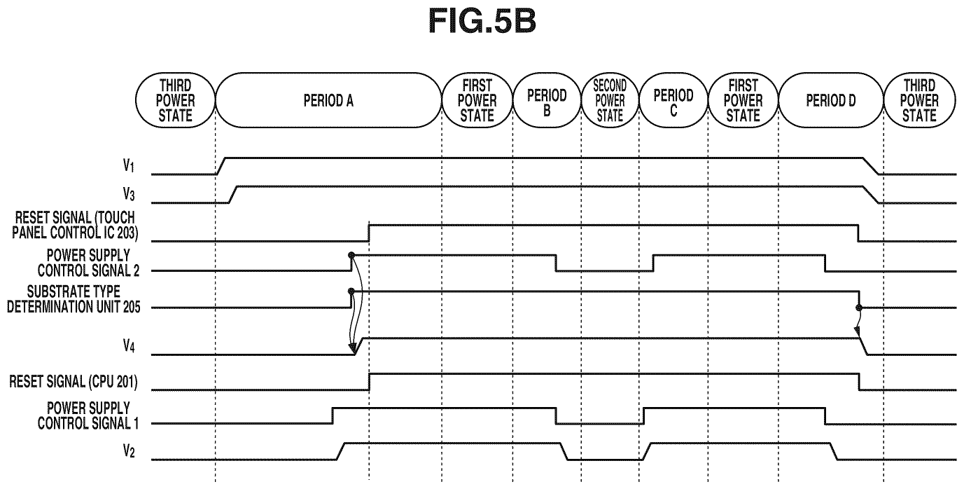

In FIG. 4A, the power supply voltage V_{b} is a power supply voltage supplied in the first power state, but not supplied in the second power state. Details thereof will be described with reference to FIG. 5A. The power supply voltage V_{b} is turned on after the power supply voltage V₃ is turned on.

Next, with reference to FIG. 4B, states of potentials of the substrate type determination signal and the power supply control signal 2 will be described. FIG. 4B is a diagram illustrating a case where the operation unit 200 is connected to the control unit 100 in a configuration in which the human detection sensor 204 is mounted, i.e., the recovery time to the first power state is prioritized over the reduction of the power consumption in the second power state. In FIG. 4B, since the substrate type determination signal is pulled up to a power supply voltage Vₐ at a terminal of the operation unit I/F 107 of the control unit 100, when the power supply voltage Vₐ is turned on, the potential of the terminal is high. Thus, in the case where the substrate type determination signal is high, it is possible to determine that the human detection sensor 204 is mounted. The power supply control signal 2 is subjected to the similar processing in FIG. 4A.

In FIG. 4B, the power supply voltage Vₐ is a power supply voltage supplied both in the first power state and the second power state. Details thereof will be described with reference to FIG. 5B.

The functional modules, the various kinds of power supplies, and the signals described above will be described along with the change of the power state of the image forming apparatus 10 with reference to timing charts.

FIG. 5A is a timing chart in the case where the human detection sensor 204 is not mounted, as in FIG. 4A. Description of the timing chart starts from the third power state. In the third power state, when a power switch of the image forming apparatus 10 is pressed, the image forming apparatus 10 starts shifting to the first power state. In the third power state, all the power supplies and signals are low. Next, in a period A, when the system of the image forming apparatus 10 is activated, the power supply voltage V₁ supplied from the control unit 100 to the operation unit 200 rises. As described above, the power supply voltage V₃ also rises following the rise of the power supply voltage V₁. Next, the power supply control signal 1 is asserted, and supply of the power supply voltage V₂ to the LCD 207 is started. Then, when the power supply voltage V_{b} in FIG. 4A is turned on, the power supply control signal 2 rises, the transistor Tr₂ in FIG. 3 is turned on, and the power supply voltage V₄ starts rising. When the power supply voltage V₄ reaches a specified voltage, and the CPU 201 becomes operable, a reset control circuit (not illustrated) deasserts (changes from low to high) reset signals of the touch panel control IC 203 and the CPU 201. At this time, since the touch panel control IC 203 is an IC controlled by the CPU 201, the touch panel control IC 203 is kept being reset until the CPU 201 becomes operable. When the control in the period A is completed, the power state shifts to the first power state.

In a period B, the power state shifts from the first power state to the second power state. A trigger for the shift from the first power state to the second power state is, for example, a sleep shift instruction from the user or an elapse of a predetermined time without the touch panel 208 being operated. First, the power supply control signal 2 becomes low because the power supply voltage V_{b} is not supplied in the control unit 100. With this operation, since the substrate type determination signal is low as illustrated in FIG. 4A, the transistor Tr₂ is turned off, and accordingly the power supply voltage V₄ is not supplied. At this time, assume that the reset signal to the CPU 201 is asserted (changed from high to low) by the reset control circuit (not illustrated) before the supply of the power supply voltage V₄ is stopped. Further, the power supply control signal 1 is deasserted, and supply of the power supply voltage V₂ is stopped.

With these operations, since the power supply to the CPU 201 is stopped in the second power state, the power consumption of the operation unit 200 is minimized, and accordingly, the power consumption of the image forming apparatus 10 is minimized. Further, since the system of the image forming apparatus 10 is to be recovered by a press on the touch panel 208 by the user, the power supply voltage V₃ needs to be kept being supplied.

A period C is a period in which the power state shifts from the second power state to the first power state, for example, by a press on the touch panel 208 by the user. Since the power supply voltage V_{b} is supplied by the recovery interrupt signal output from the touch panel control IC 203 to the power supply control unit 110, the power supply control signal 2 becomes high. With this operation, the transistor Tr₂ is turned on again, and the power supply voltage V₄ starts rising. When the power supply voltage V₄ reaches the specified voltage, the reset signal to the CPU 201 is deasserted by the reset control circuit (not illustrated), as in the period A. Further, the power supply control signal 1 is asserted, and the power supply voltage V₂ also starts rising. When the processing is completed, the power state shifts to the first power state.

A period D is a period in which, for example, the power switch (not illustrated) disposed on the image forming apparatus 10 is turned off by a user, and thus the functional modules are turned off. First, the power supply control signal 2 becomes low because the power supply voltage V_{b} is not supplied in the control unit 100. With this operation, since the substrate type determination signal is low as illustrated in FIG. 4A, the transistor Tr₂ is turned off, and accordingly the power supply voltage V₄ is not supplied. At this time, assume that the reset signal to the CPU 201 is asserted by the reset control circuit (not illustrated) before the supply of the power supply voltage V₄ is stopped. Further, the power supply control signal 1 is deasserted to stop supplying the power supply voltage V₂. At last, the power supply voltage V₁ supplied from the control unit 100 starts falling, and the power supply voltage V₃ starts falling following the power supply voltage V₁. In this case, assume that the reset signal to the touch panel control IC 203 is asserted by the reset control circuit (not illustrated) before the falling of the power supply voltage V₃.

FIG. 5B is a timing chart in the case where the human detection sensor 204 is mounted, as in FIG. 4B. Note that portions not different from those in FIG. 5A are not described.

In the period A, the substrate type determination unit 205 (substrate type determination signal) becomes high when the power supply voltage Vₐ is turned on. As described above, the power supply voltage Vₐ is a power supply voltage to be turned on both in the first power state and the second power state. The transistor Tr₂ turns on by the rises of the power supply control signal 2 and the substrate type determination unit 205, and the power supply voltage V₄ starts rising. Either the power supply control signal 2 or the substrate type determination unit 205 may rise first, but in the present exemplary embodiment, it is assumed that the substrate type determination unit 205 rises first.

In the period B, a fall of the power supply voltage V_{b} causes the power supply control signal 2 to fall, but since the power supply voltage Vₐ stays on in the second power state, the substrate type determination unit 205 is high, the transistor Tr₂ stays on, and the power supply voltage V₄ also stays on. With this operation, the CPU 201 and the human detection sensor 204 become operable in the second power state. Accordingly, when the human detection sensor 204 detects a user's approach in the second power state, the CPU 201 asserts the recovery interrupt signal, and the image forming apparatus 10 returns to the first power state.

In the period D, the basic operation is similar to that in FIG. 5A, but the operation is different in that, since the power supply voltage V₄ is controlled by a logical sum of the power supply control signal 2 and the substrate type determination unit 205, the supply of the power supply voltage V₄ is stopped after both of the signals become low. In the present exemplary embodiment, assume that the substrate type determination unit 205 becomes low after the power supply control signal 2 becomes low, i.e., the power supply voltage Vₐ becomes low after the power supply voltage V_{b} becomes low.

With the above-described configuration, in the case where the human detection sensor 204 is mounted, the substrate type determination signal becomes high, and when the substrate type determination unit 205 determines that the potential is high, the power supply voltage V₄ is controlled to be supplied to the CPU 201 based on the determination result. On the other hand, in the case where the human detection sensor 204 is not mounted, the substrate type determination signal becomes low, and when the substrate type determination unit 205 determines that the potential is low, the power supply voltage V₄ is controlled not to be supplied to the CPU 201 based on the determination result. In this way, based on whether the human detection sensor 204 is mounted, it is possible to achieve, with a simpler configuration, the power saving state with the human detection sensor 204 mounted in which the recovery time to return to a normal operation state is fast and the state without the human detection sensor 204 mounted in which the power consumption of the operation unit 200 is minimized by not supplying power to the CPU 201.

In a second exemplary embodiment, an example in which the substrate type determination unit 205, which is included in the operation unit 200 according to the first exemplary embodiment, is included in the control unit 100 will be described. Note that portions, such as the system configuration and the operations of the circuits, not different from those in the first exemplary embodiment will not be described.

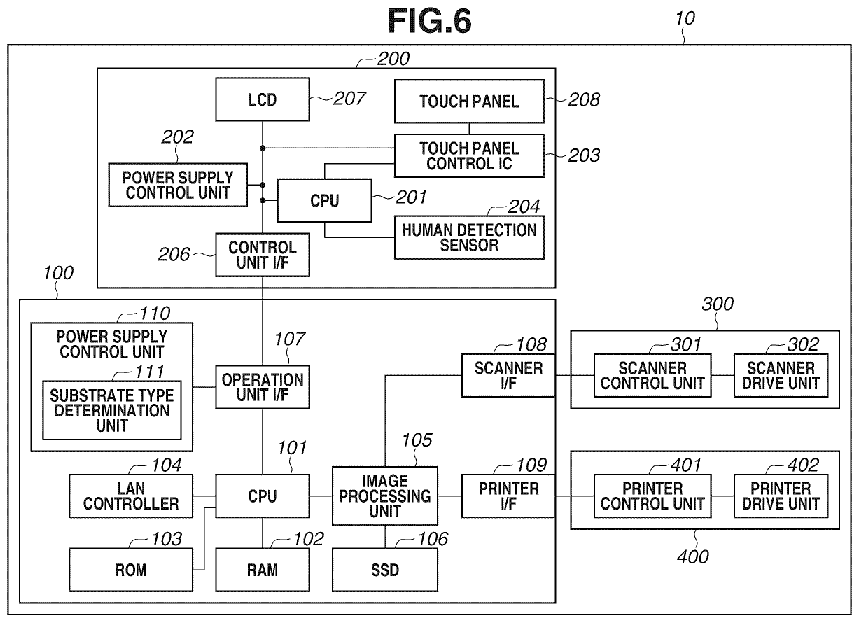

FIG. 6 is a block diagram illustrating a system configuration of an image forming apparatus 10 according to the present exemplary embodiment. Unlike in the first exemplary embodiment, the substrate type determination unit 205 according to the first exemplary embodiment is included in the control unit 100 as a substrate type determination unit 111 in the second exemplary embodiment. More specifically, the substrate type determination unit 111 is included in the power supply control unit 110. Thus, in the present exemplary embodiment, the control unit 100 determines its own substrate type and feeds back a result to the control of the power supply control circuit 210 of the operation unit 200.

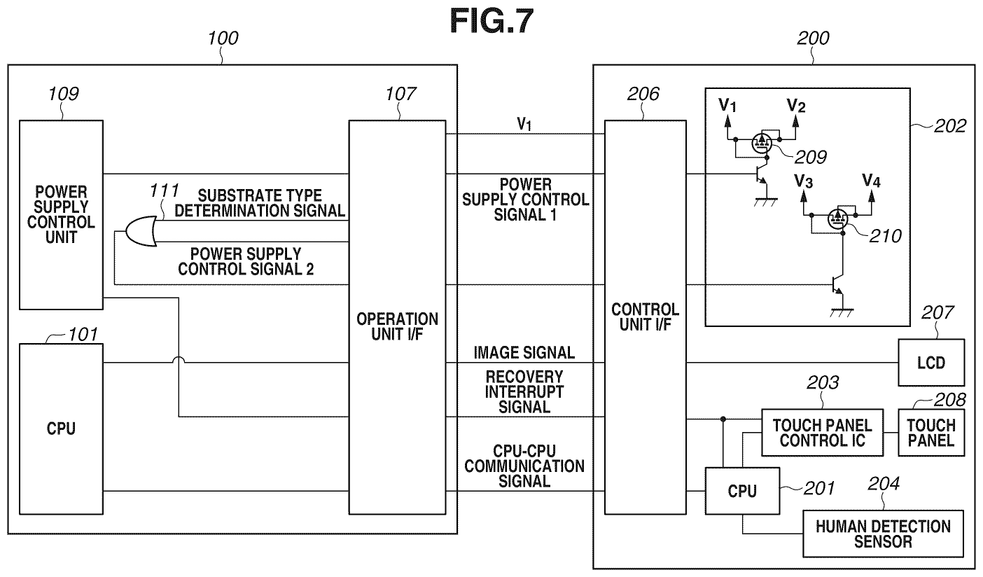

FIG. 7 is a block diagram illustrating details of the connection state between the control unit 100 and the operation unit 200 according to the present exemplary embodiment. A logical sum of the substrate type determination unit 111 (substrate type determination signal) and the power supply control signal 2 are taken by the logic IC, and as describe above, the substrate type determination unit 111 is used as the control signal to the power supply control circuit 210 of the operation unit 200.

In this way, timings of turning on the power supply voltage V₄ supplied to the CPU 201 and the human detection sensor 204 are controlled.

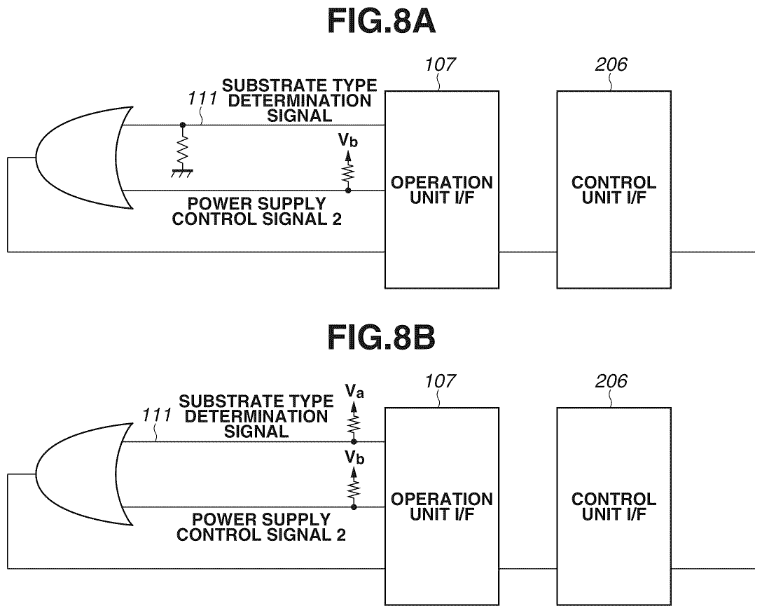

Next, with reference to FIGS. 8A and 8B, states of potentials of the substrate type determination signal and the power supply control signal 2 will be described.

FIG. 8A is a diagram illustrating a case where the operation unit 200 is connected to the control unit 100 in a configuration in which the human detection sensor 204 is not mounted, i.e., the power consumption is significantly reduced in the second power state. First, the substrate type determination signal is pulled down at a terminal of the operation unit I/F 107 of the control unit 100 to be low. Thus, the control unit 100 makes the substrate type determination signal low to indicate that the human detection sensor 204 is mounted on the control unit 100. On the other hand, the power supply control signal is pulled up to the power supply voltage V_{b}, and when the power supply voltage V_{b} is turned on, the power supply control signal is high. At this time, assume that the power supply voltage V_{b} is a power supply voltage turned on in the first power state and not turned on in the second power state, as in the first exemplary embodiment.

FIG. 8B is a diagram illustrating a case where the operation unit 200 is connected to the control unit 100 in a configuration in which the human detection sensor 204 is mounted, i.e., the recovery time to the first power state is prioritized over the reduction of the power consumption in the second power state. Since the substrate type determination signal is pulled up to the power supply voltage Vₐ, it is high when the power supply voltage Vₐ is turned on. Further, since the power supply control signal 2 is also pulled up to the power supply voltage V_{b}, it is high when the power supply voltage V_{b} is turned on. Also in the second exemplary embodiment, assume that the power supply voltage Vₐ is a power supply voltage that is turned on both in the first power state and the second power state.

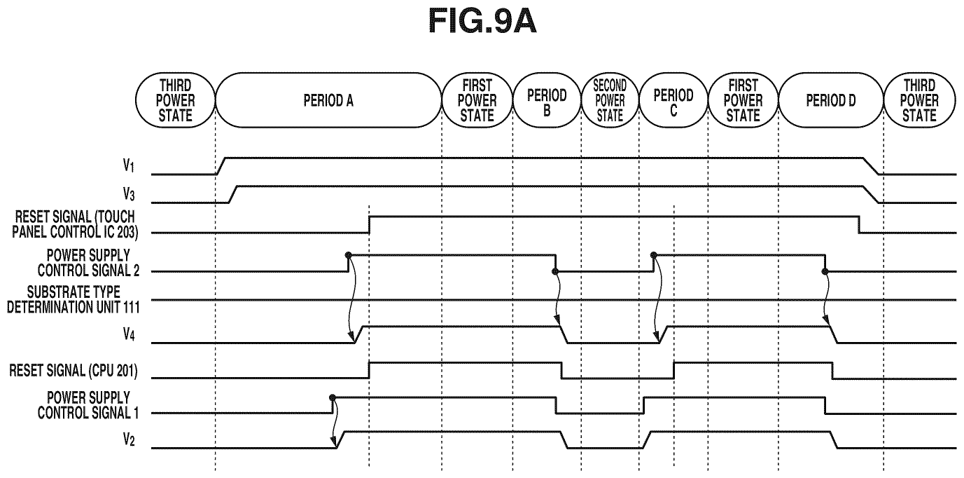

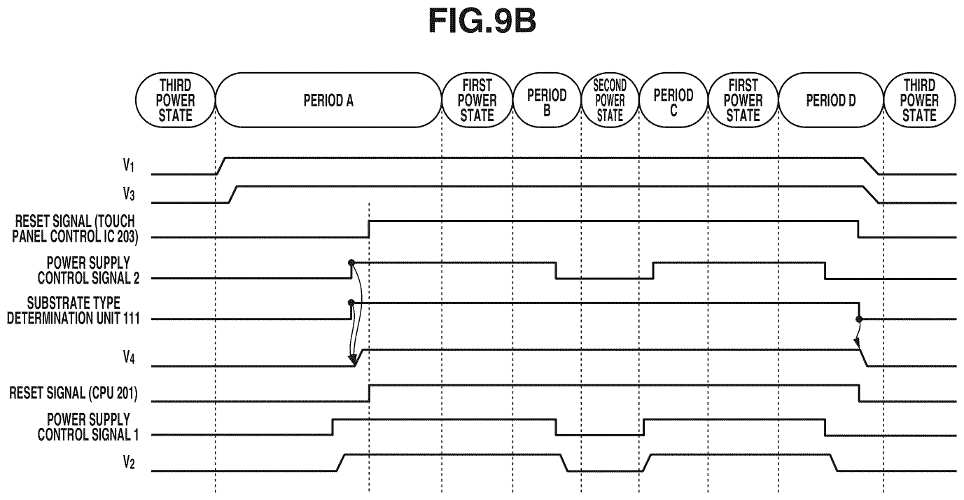

The functional modules, the various kinds of power supplies, and the signals described above will be described along with the change of the power state of the image forming apparatus 10 with reference to timing charts in FIGS. 9A and 9B.

FIG. 9A is a timing chart in the case where the human detection sensor 204 is not mounted, as in FIG. 8A. The operation of the image forming apparatus 10 is similar to that in FIG. 5A according to the first exemplary embodiment except that the operation of the substrate type determination unit 205 is changed to that of the substrate type determination unit 111. In the present exemplary embodiment, since the substrate type determination unit 111 is pulled down to low by the power supply control unit 110, the substrate type determination unit 111 is low in all the states as illustrated in FIG. 9A. Thus, only when the power supply voltage V_{b} is turned on and the power supply control signal 2 becomes high, the power supply voltage V₄ is turned on. Thus, in FIG. 9A, since the supply of the power supply voltage V_{b} is stopped and accordingly the supply of the power supply voltage V₄ is stopped in the second power state, the power consumption in the second power state can be minimized.

On the other hand, FIG. 9B is a timing chart in the case where the human detection sensor 204 is mounted, as in FIG. 8B. The operation of the image forming apparatus 10 is similar to that in FIG. 5B according to the first exemplary embodiment except that the substrate type determination unit 205 is replaced with the substrate type determination unit 111. Further, also in the present exemplary embodiment, it is assumed that the substrate type determination unit 111 rises before the power supply control signal 2 rises, but the configuration is not limited thereto. In FIG. 9B, since the substrate type determination unit 111 is pulled up to the power supply voltage Vₐ, the power supply voltage V₄ is kept being turned on in the second power state. In this way, the CPU 201 can detect a user's approach by the human detection sensor 204 even in the second power state. Thus, the system of the image forming apparatus 10 can be returned to the first power state by the recovery interrupt signal.

In this way, unlike in the first exemplary embodiment, it is also possible to appropriately control the power state in the power saving time of the image forming apparatus 10 by the power supply control unit 110 determining its own substrate type.

In a third exemplary embodiment, a configuration in which the control unit 100 determines whether the human detection sensor 204, which is connected to the operation unit 200 as an option, is present will be described. More specifically, as described in the first and second exemplary embodiments, there are cases where the human detection sensor 204 is mounted and not mounted, because when a user buys the image forming apparatus 10, the user can select whether to mount the human detection sensor 204. Naturally, in the present exemplary embodiment, the device to be connected as the option is assumed to be the human detection sensor 204, but presence of a device different from the human detection sensor 204 may be determined. Note that portions, such as the system configuration and the operations of the circuits, not different from those in the first and second exemplary embodiments will not be described.

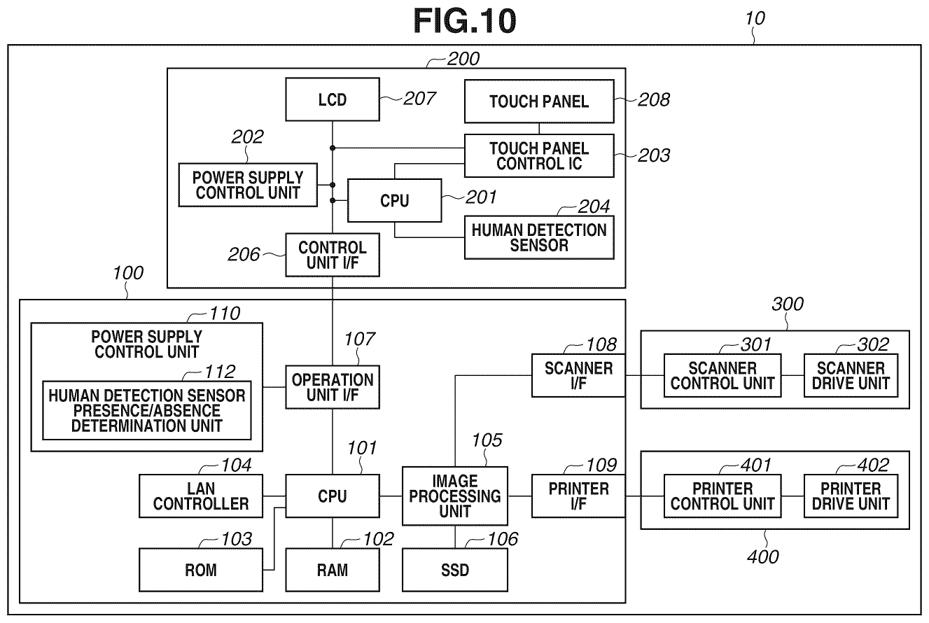

FIG. 10 is a block diagram illustrating a system configuration of the image forming apparatus 10 according to the third exemplary embodiment. The present exemplary embodiment is characterized in that the power supply control unit 110 of the control unit 100 includes a human detection sensor presence/absence determination unit 112. The human detection sensor herein refers to the human detection sensor 204 included in the operation unit 200.

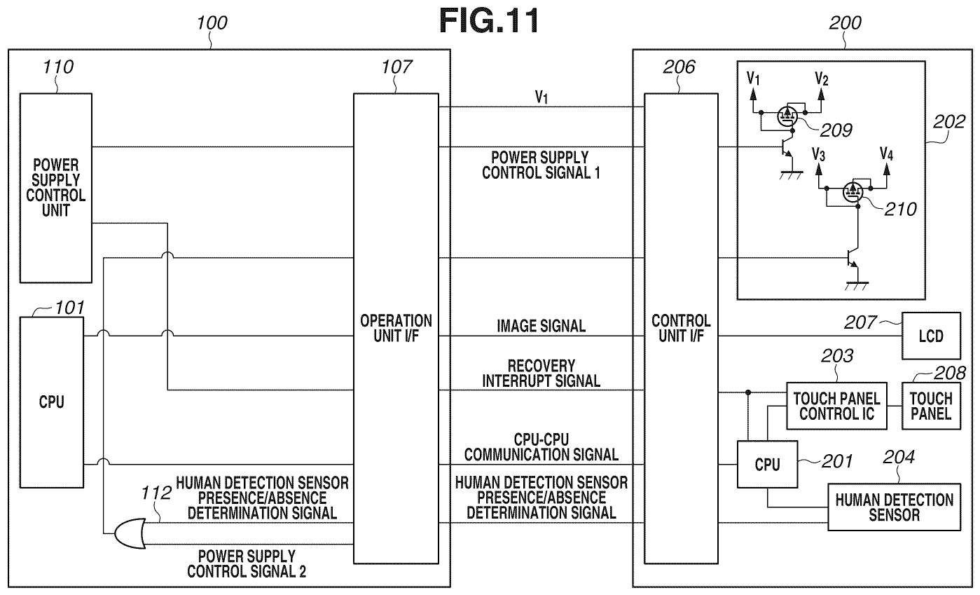

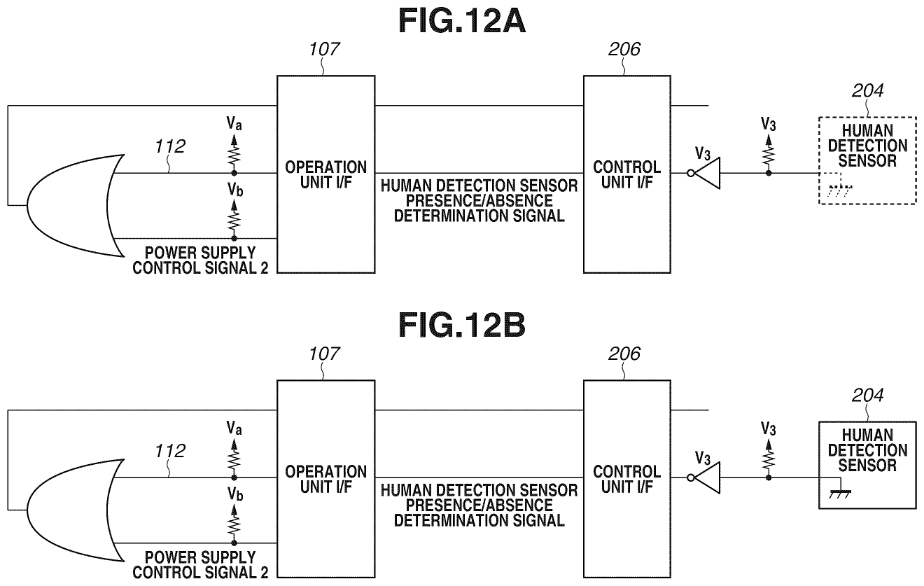

Next, with reference to FIG. 11, a connection state of the operation unit I/F 107 and the control unit I/F 206 will be described in detail. In the third exemplary embodiment, a generation method of a signal transmitted to the power supply control circuit 210 is different from that in the first and second exemplary embodiments. More specifically, the signal is generated by a logical sum of the power supply control signal 2 and a human detection sensor presence/absence determination signal (human detection sensor presence/absence determination unit 112) whose potential on a transmission path (signal line) is uniquely determined to be high or low depending on whether the human detection sensor 204 is present. Since the human detection sensor 204 is assumed to be mounted on a commonly used printed circuit board (PCB) by soldering, it is possible to control the potential on a specific signal line depending on whether the human detection sensor 204 is mounted. Details thereof will be described below with reference to FIG. 12B.

FIG. 12A is a diagram illustrating the case where the operation unit 200 is connected to the control unit 100 in a configuration in which the human detection sensor 204 is not mounted, i.e., the power consumption is significantly reduced in the second power state. As illustrated in FIG. 12A, the human detection sensor presence/absence determination signal is pulled up to the power supply voltage Vₐ in the control unit 100 and to the power supply voltage V₃ in the operation unit 200. In the operation unit 200, after the human detection sensor presence/absence determination signal is pulled up, the logic thereof is inverted by a logic IC (inverter) in the latter stage, and the inverted human detection sensor presence/absence determination signal is transmitted from the control unit I/F 206 to the operation unit I/F 107. As illustrated in FIG. 12A, since the human detection sensor 204 is not mounted, the potential of the human detection sensor presence/absence determination signal at a terminal of the operation unit I/F 107 becomes low while the inverter is energized. In the present exemplary embodiment, assume that the inverter is driven by the power supply voltage V₃. On the other hand, since the power supply control signal 2 is pulled up to the power supply voltage V_{b}, it becomes high while the power supply voltage V_{b} is turned on. The signal generated by the logic IC that takes a logical sum of the human detection sensor presence/absence determination signal and the power supply control signal 2 is transmitted from the operation unit I/F 107 to the control unit I/F 206 and used to control the power supply control circuit 210 as illustrated in FIG. 11. Also in the present exemplary embodiment, assume that while the power supply voltage Vₐ is turned on both in the first power state and the second power state, the power supply voltage V_{b} is turned on in the first power state, but not turned on in the second power state.

FIG. 12B is a diagram illustrating a case where the operation unit 200 is connected to the control unit 100 in a configuration in which the human detection sensor 204 is mounted, i.e., the recovery time to the first power state is prioritized over the reduction of the power consumption in the second power state. FIG. 12B is the same as FIG. 12A except that the human detection sensor 204 is mounted. In FIG. 12B, assume that the human detection sensor presence/absence determination signal is connected to a specific ground terminal included in the human detection sensor 204. Thus, in a case where the human detection sensor 204 is mounted, the input to the inverter included in the operation unit 200 becomes low. Accordingly, the output of the inverter becomes high and is transmitted from the control unit I/F 206 to the operation unit I/F 107. Then, a signal generated by the logical sum of this signal and the power supply control signal 2 is transmitted from the operation unit I/F 107 to the control unit I/F 206.

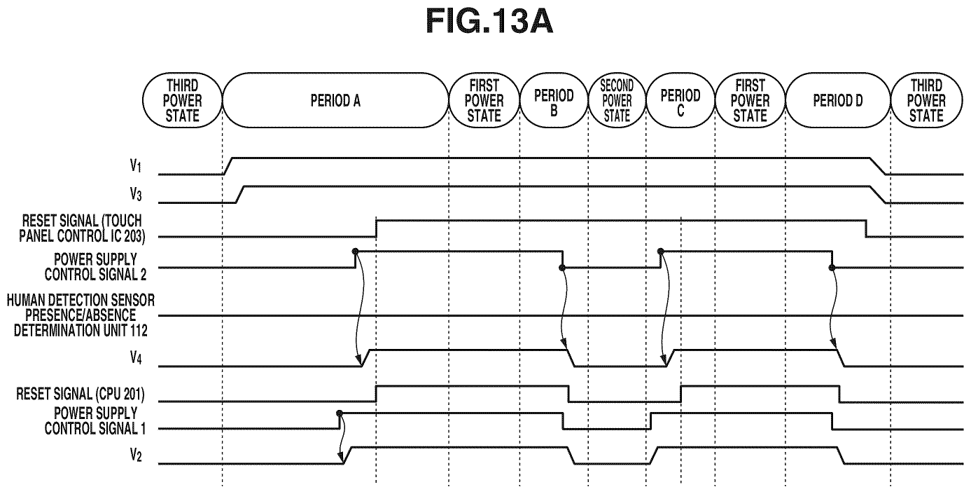

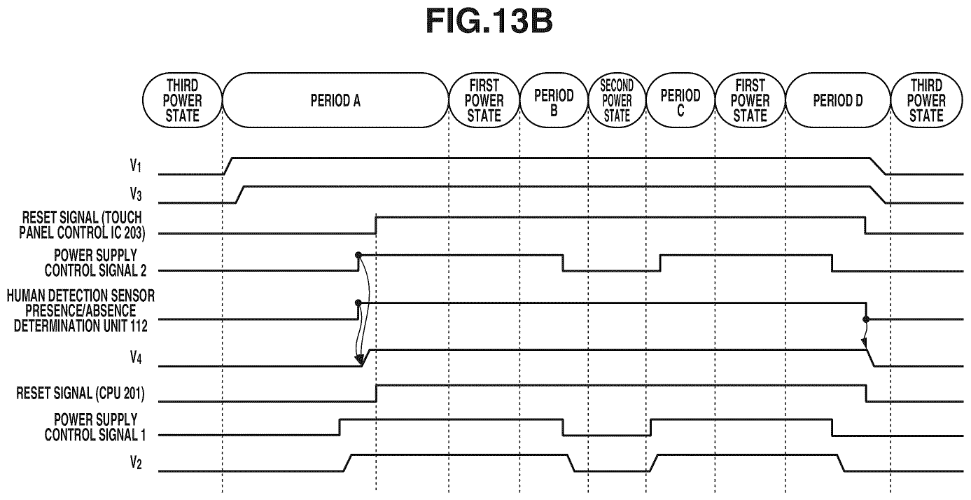

Next, with reference to FIG. 13A, a timing chart of the various functional modules, the various kinds of power supplies, and the signals in the configuration of the connection diagram in FIG. 12A will be described. FIG. 13A is a timing chart in the case where the human detection sensor 204 is not mounted, as in FIG. 12A. The operation of the image forming apparatus 10 is similar to that in FIG. 9A according to the second exemplary embodiment except that the operation of the substrate type determination unit 111 is changed to that of the human detection sensor presence/absence determination unit 112 (human detection sensor presence/absence determination signal). In the period A, since the human detection sensor presence/absence determination signal becomes low and is output by the operation unit 200, the human detection sensor presence/absence determination signal is low in all the states as illustrated in FIG. 13A. Thus, only when the power supply voltage V_{b} is turned on and the power supply control signal 2 becomes high, the power supply voltage V₄ is turned on. Thus, in FIG. 13A, since the supply of the power supply voltage V_{b} is stopped and accordingly the supply of the power supply voltage V₄ is stopped in the second power state, the power consumption in the second power state can be minimized.

On the other hand, FIG. 13B is a timing chart in the case where the human detection sensor 204 is mounted, as in FIG. 12B. The operation of the image forming apparatus 10 is similar to that in FIG. 9B according to the second exemplary embodiment except that the operation of the substrate type determination unit 111 is changed to that of the human detection sensor presence/absence determination unit 112 (human detection sensor presence/absence determination signal). Further, also in the present exemplary embodiment, it is assumed that the human detection sensor presence/absence determination unit 112 rises before the power supply control signal 2 rises, but the configuration is not limited thereto. In FIG. 13B, since the human detection sensor 204 is mounted, as described above, the human detection sensor presence/absence determination signal becomes high and is input to the control unit 100. Thus, the power supply voltage V₄ is kept being turned on even in the second power state. In this way, the CPU 201 can detect a user's approach by the human detection sensor 204 even in the second power state. Then, the system of the image forming apparatus 10 can be returned to the first power state by the recovery interrupt signal.

In this way, unlike in the first and second exemplary embodiments, it is also possible to appropriately control the power state in the power saving time of the image forming apparatus 10 by the power supply control unit 110 determining whether a specific device is mounted on the operation unit 200.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to Japanese Patent Application No. 2023-142747, which was filed on Sep. 4, 2023 and which is hereby incorporated by reference herein in its entirety.

What is claimed is:

1. An electronic apparatus comprising:
a first substrate on which a first central processing unit (CPU) is mounted;
a second substrate on which a second CPU is mounted and a specific function is mountable; and
a power supply control unit configured to control power supply from a power source,
wherein the power supply control unit controls the power supply to the second CPU when the electronic apparatus shifts to a power saving state depending on a determination result of whether the power supply to the second CPU is required in a case where the electronic apparatus is in the power saving state based on whether the specific function is mounted on the second substrate.

2. The electronic apparatus according to claim 1, wherein the specific function is a human detection sensor.

3. The electronic apparatus according to claim 1, wherein the power saving state is a state where the power supply to the first CPU is interrupted.

4. The electronic apparatus according to claim 1, further comprising a transmission line connecting the first substrate and the second substrate, wherein the power supply control unit determines whether the specific function is mounted on the second substrate using a potential on the transmission line.

5. The electronic apparatus according to claim 4, wherein a determination using the potential is performed using only one signal on the transmission line.

6. The electronic apparatus according to claim 1, wherein the power supply control unit is mounted on the first substrate.

7. The electronic apparatus according to claim 1, wherein the power supply control unit is mounted on the second substrate.

8. The electronic apparatus according to claim 1, wherein a shift to the power saving state is a shift from a state where power is supplied to the first CPU to a state where power is not supplied at least to the first CPU.

9. The electronic apparatus according to claim 1, wherein the power source used by the second CPU is generated in the second substrate.

10. The electronic apparatus according to claim 1, wherein each of the first and second substrates is a printed circuit board.

11. A control method for an electronic apparatus including a first substrate on which a first CPU is mounted, a second substrate on which a second CPU is mounted and a specific function is mountable, and a power supply control unit configured to control power supply from a power source, the control method comprising:
controlling the power supply to the second CPU when the electronic apparatus shifts to a power saving state depending on a determination result of whether the power supply to the second CPU is required in a case where the electronic apparatus is in the power saving state based on whether the specific function is mounted on the second substrate.
